(19) United States
(12) Patent Application Publication
(10) Pub. No.: US 2010/0061709 A1
(43) Pub. Date: Mar. 11, 2010

(54) Ad Menu for skipped advertisements

(76) Inventors: Davender Agnihotri, Murrieta, CA (US); Brant L. Candelore, San Diego, CA (US)

Correspondence Address: MILLER PATENT SERVICES, 2500 DOCKERY LANE, RALEIGH, NC, 27606, US

(21) Appl. No.: 12/231,721

(22) Filed: Sep. 5, 2008

(51) Int. Cl. H04N 7/26

(52) U.S. Cl. 386/124; 386/E05.001

(57) ABSTRACT

A method of operation of a personal video recorder (PVR) involves receiving and storing a plurality of commercial advertisements forming a part of a stream of program content at the PVR; receiving and storing metadata associated with the plurality of commercial advertisements at the PVR; storing an index to the one or more commercial advertisements at the PVR; ascertaining that the end of the stream of program content has been reached; as a result of the ascertaining, using the stored index to retrieve metadata associated with the one or more commercial advertisements; building a menu of commercial advertisements from the retrieved metadata for the advertisements; generating a signal that displays the menu to the user and provides the user with an option of viewing the commercials; if the user chooses not to view the commercials, ceasing to generate the signal that displays the menu; if the user chooses to view a commercial, then receiving a selection of a commercial advertisement that the user wishes to view; and retrieving the commercial advertisement for viewing by the user. This abstract is not to be considered limiting, since other embodiments may deviate from the features described in this abstract.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

The vast majority of the U.S. population obtains their television (TV) signal from either cable, satellite or Telcos. Currently all known providers can supply their customers with Personal Video Recorders (PVRs—also referred to as Digital Video Recorders or DVRs), or alternatively, a customer can purchase his or her own PVR. PVRs have grown in popularity in recent years and more and more of these units are being deployed in the homes of consumers. All models of these PVRs currently have a way for the consumer to fast forward and/or skip advertisements via a single configurable click of the remote.

Currently it is common practice for those who own or lease a personal video recorder (PVR—or equivalently digital video recorder—DVR) to fast forward and/or skip over advertisements when playing back recorded content (including content that is “live” but has been “paused” for a period of time). This is starting to represent a huge loss of revenue (literally in the order of many hundreds of millions and billions of dollars) since often the user is not exposed to and thus has no knowledge of the advertisements (commercials) that are skipped over. The device manufacturers and service providers have an uphill battle to entice consumers to not skip over embedded commercials that serve as a source of revenue.

One manufacturer tried to eliminate the “skip” feature on their remote control, but was faced with a consumer revolt that resulted in the manufacturer putting the feature back in. Content providers remain unhappy with the current situation, since if consumers do not watch the commercials, they in turn cannot charge as high a premium from advertisers. Since advertising revenue supports the programming, and consumers satisfaction must be maintained, there exists a conflict that ultimately harms the whole industry and its consumers.

Solutions to this problem have been proposed. One commonly proposed solution is the disabling of the skip feature during the commercial, e.g. for VOD (content streamed from the headend). Advertisements on the Internet currently use this methodology, but it leads to user dissatisfaction. So some of the ads now have a “skip this intro commercial” button on the advertisement.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is an example block diagram of a content distribution system consistent with certain embodiments of the present invention.

FIG. 2 is an illustration of an example segment of A/V content.

FIG. 3 is an illustration of an example embodiment of a data flow arrangement consistent with certain embodiments of the present invention.

FIG. 4 is an illustration of an example embodiment of a data flow arrangement consistent with certain embodiments of the present invention.

FIG. 5 is an illustration of an example embodiment of a data flow arrangement for advertisement metadata consistent with certain embodiments of the present invention.

FIG. 6 is an example implementation of a process for assembly, storage and transport of advertisement content and metadata to a subscriber in a manner consistent with certain embodiments of the present invention.

FIG. 7 is an example implementation of a process for display of advertisements and advertisement menus in a manner consistent with certain embodiments of the present invention.

FIG. 8 is an illustrative example screen shot of a menu system consistent with certain embodiments of the present invention.

FIG. 9 is an example implementation of a process for display of advertisements and advertisement menus in a manner consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program” or “computer program” or similar terms, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system. The term “program”, as used herein, may also be used in a second context (the above definition being for the first context). In the second context, the term is used in the sense of a “television program”. In this context, the term is used to mean any coherent sequence of audio video content such as those which would be interpreted as and reported in an electronic program guide (EPG) as a single television program, without regard for whether the content is a movie, sporting event, segment of a multi-part series, news broadcast, etc.

The term advertisement in this document is generally intended to represent a conventional television advertisement segment such as those often referred to as a commercial or a commercial spot which are not conventionally reported as a program in an electronic program guide.

Reference throughout this document to “one embodiment”, “certain embodiments”, “an embodiment”, “implementations”, “examples” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive. The term “skip” as used herein means any action taken by a user to skip over or fast forward through a commercial advertisement without full viewing of the commercial advertisement.

In view of the problems noted above, it is desirable to attempt to recoup some of these lost advertisement dollars in a way that is user friendly. Hence in certain implementations, metadata about advertisements is delivered with a program so that the PVR can create a pop-up banner at the end of content play-back. The user can use an ordinary remote control to highlight and select one of the ads for playback if he or she so desires.

In the first example embodiment, the advertisement metadata is bound with the advertisement itself (in the same packets and in private data fields of the adaptation layer of those transport packets). The PVR can monitor this data to create an index to the advertisement location for all ads carried with an associated program. In this scenario, the advertiser would mark his own advertisement according to a PVR manufacturer's specification.

The second example embodiment delivers this metadata in separate packets marked by a different Packet ID (PID). The information can be similar as that sent by the adaptation method described above. In addition, the placement of these packets can be bound to an advertisement, for example, in front and at the end of an advertisement. So the structure of the streams with the marker packets can help a decoder determine where an advertisement starts and stops. This method is good for ads which do not support the first embodiment, and would not require re-encoding the advertisement to include the metadata in the adaptation fields.

A third illustrative example embodiment delivers metadata as data sent with electronic program guide data where ads are treated as sub-segments. The information can be similar to that sent by the adaptation method or separate packet method described above. Similar clock and timing information used to trigger recording of a program may be used to record advertisements. Other embodiments and implementations will occur to those skilled in the art upon consideration of the present teachings.

In certain embodiments, the metadata for each commercial advertisement includes descriptor data (e.g., a name of the advertiser or other descriptor), a start and end point (such as packet numbers or other locator) for each advertisement and a thumbnail frame or a packet identifier for an I frame of video within the advertisement that is to be used as a thumbnail representation of the commercial spot.

In a pop-up window that appears at the end of a program, the user can be given the option of playing the content again, erasing the content, or watching commercials which may have been skipped. The commercials in this case can be all commercials or only those that were skipped and are those commercials that were sent with the content. The commercials include or as a part thereof advertisement metadata or such metadata can be separately provided, for example using a separate packet identifier (PID). In this manner, the PVR can get access to the advertisement metadata and can determine a location of the advertisement on the hard disc drive (HDD) used to store the commercial on the PVR. Consequently, the pop-up window can list the ads by advertiser and particular brand name or by other identifying information and can incorporate a thumbnail image from the advertisement to further entice the user to view the advertisement. The user can interact with the window to make menu selections by use of navigation controls on a remote control device to manipulate a cursor over one of the advertisements in order to select it.

In one example embodiment metadata is carried with each commercial and the PVR keeps track of the commercial using index pointers. This allows the PVR to list all commercials viewed or skipped at the end of the program viewing. Alternatively, or additionally, whenever a viewer hits pause a banner can pop-up asking the viewer if they want to want to save the advertisement.

With pointers to the actual commercials in the live stream recorded on the PVR, if the user chooses to do so they can click on and go back to view a skipped commercial. The list at the end would be a list of ads from the last pause or a master list of all commercials in the program (with pointers to those commercials). A message to the viewer inviting them to view the commercials they might be interested in can be displayed with the lists or using any other suitable user interface. The intent is to not completely take away user choice to skip over commercials, but instead gives the user a choice to view commercials they are most interested in. This allows for the commercials to be skipped, but with a pop-up can be non-annoying and not intrusive in the viewing experience.

Targeted advertising has been the goal for most modern advertisers and is considered much more effective and generates a much higher “buy rate” than simple blanket advertising where an advertiser might want to cover the widest possible audience. The viewing of these user selected commercials can be tracked which actually gives the advertiser useful data about the viewers buying habits. The user selected commercials can be tracked and thus data can be compiled and used for targeted advertising as well as feedback for commercial producers about the effectiveness of their commercials.

If advertisement data is carried on a separate packets marked by different PIDs, then it may be encrypted. The encryption can be used to keep someone from creating an advertisement killer function. It would be desirable to prevent a PVR manufacturer from recording “clean content” without any ads at all.

The pop-up banner itself can have thumbnails that serve as mini-advertisements. In other words, when the pop-up queries the user as to whether he or she wishes to watch commercials, the user is presented with a thumbnail and a product, business or service name creating an advertisement opportunity in its own right.

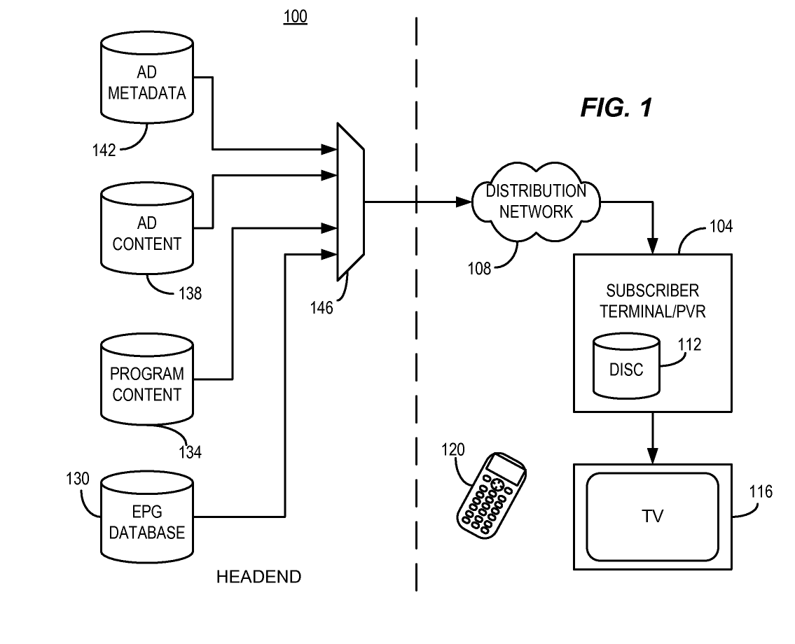

In order to more clearly understand some of the various embodiments consistent with the present invention, the reader is referred to FIG. 1, which depicts a basic block diagram of a distribution system consistent with the present invention. It will be appreciated that in most such systems, the headend 100 serves as a source for content supplied to a collection of subscriber terminals 104 through a distribution network 108 such as a cable or satellite or Telco network. Content is received at the subscriber terminal which can include an attached or integral storage medium such as a hard disc drive 112 operating under control of a programmed processor to implement PVR functions. The subscriber terminal may be in the form of a television set top box (STB) or other television receiver device 116 without limitation and provides content to television display device 116, each of which can operate under control of one or more remote controllers 120.

The headend 100 conceptually includes massive data storage abilities including storage for an electronic program guide (EPG) shown as 130 and program content 134. The EPG data is made up of metadata associated with the program content that is configurable into a matrix of information used for display of the program guide on the television's EPG when displayed. Advertisement content can also be stored as depicted symbolically at 138, although it is often an integral part of the content stored at 134. However, in the present context, it is desirable to provide ad content with metadata stored as 142. Such metadata for advertisements is not conventional, but is used in the context of the present teachings. While schematically, FIG. 1 is shown as three disc drives, no such physical limitation exists, and the depiction is for conceptual clarity. As previously mentioned, and as will be clear to those skilled in the art upon consideration of the present teachings, the headend 100 as well as the functionality to be described is carried out under control of one or more programmed processors running programs at both the headend and the subscriber side.

In accord with embodiments consistent with the present invention, content, EPG metadata, advertisements and advertisement metadata are all sent from the headend 100 to the subscribers after multiplexing at a multiplexer 146 to create transport streams. In accord with certain embodiments, the advertisement metadata can be incorporated into the transport streams as either separate data using a different packet identifier than the programming and advertisements, or can be bound to the advertisements in the private data fields of the adaptation layer as will be described later.

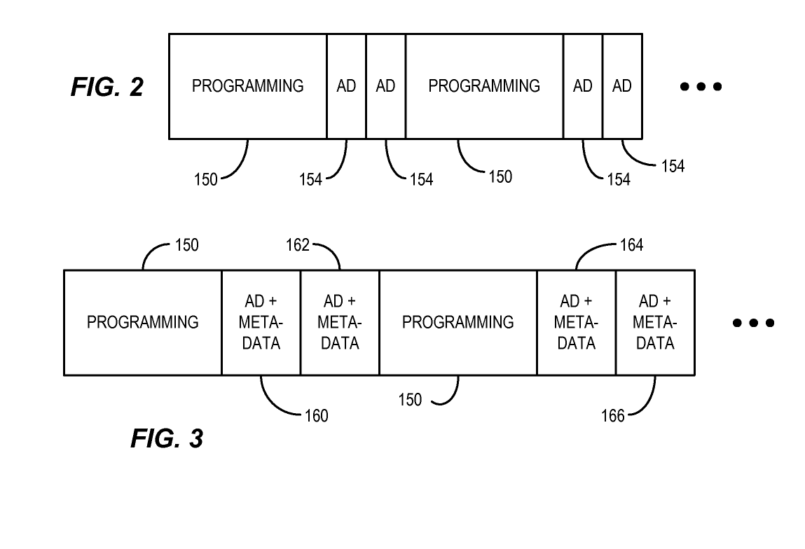

Television programming is commonly formatted as a sequence of programming such as 150 of FIG. 2 with periodic interruptions with commercial breaks or advertisements such as 154. Such content is stored as such on a PVR. Except in the case of extended length “paid programming” or so-called “infomercials”, the advertisements 154 are generally ignored for purposes of programming guides and supplied metadata. Thus, for practical purposes, the advertisements are considered to be a part of the programming itself. However, when users of a PVR encounter such advertisements, it is common, as noted above, for them to skip or fast forward through the advertisements in order to more efficiently watch a stored program of interest.

In accord with one example embodiment consistent with the present invention, as depicted in FIG. 3, the stream of data can be modified so as to bind metadata with each of the advertisements so as to permit the advertisements to be managed as discrete programming elements in the same manner as a program 150. In this example, programming 150 remains interrupted by advertisements 160, 162, 164 and 166, but each of the ads may include metadata that are bound to the advertisements, for example in the private data fields of the adaptation layer or sent as hidden data with electronic guide metadata which would also contain information about the program content. In certain implementations, the ad metadata can include a product or service description, a company name, a starting frame number, an ending frame number and either data that forms a video image thumbnail or a frame number containing an I-Frame of MPEG video that is to be used as a thumbnail.

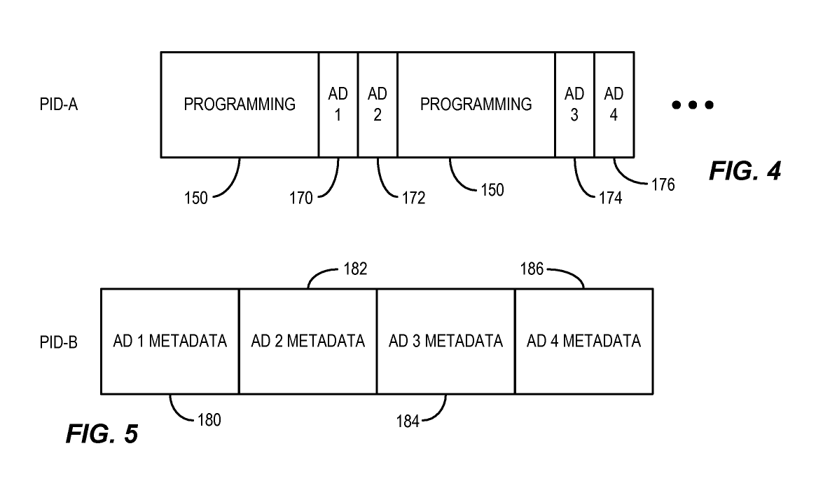

In another variation depicted in FIGS. 4 and 5, the programming 150 is interrupted by identifiable advertisements 170, 172, 174 and 176 that are identified as depicted in TABLE 1 below:

TABLE 1

| Ad Identification Table | No. of bits | Mmemonic |
|---|---|---|
| table_id | 8 | uimsbf |
| Reserved | 8 | bslbf |
| Section Length | 12 | uimsbf |
| Program Number | 16 | uimsbf |
| Reserved | 2 | bslbf |
| Version number | 5 | uimsbf |
| Current Next Indicator | 1 | bslbf |
| Section Number | 8 | uimsbf |
| Last section number | 8 | uimsbf |
| Reserved | 4 | bslbf |
| Ad_info_length | 12 | uimsbf |
| for( i =0; i<n; i++){ | | |
| Description( ) | | |
| } | | |
| for(i=0; ;i<n; i++) { | | |
| startPCR | 33 | uimsbf |
| reserved | 6 | bslbf |
| startPCR extension | 9 | uimsbf |
| endPCR | 33 | uimsbf |
| reserved | 6 | bslbf |
| endPCRextension | 9 | uimsbf |
| reserved | 3 | bslbf |
| video PID | 13 | uimsbf |
| reserved | 3 | bslbf |
| audio PID | 13 | uimsbf |
| } | | |
| CRC_32 | | |

If hidden electronic guide metadata is used, then when content is recorded, the PVR can record information not only about the content but also the ad content contained therein. Offsets to the ad segments contained with the programming can be delivered as well. Event Information Tables can be sent when an ad is presented. Ads can be given a program ID in order to facilitate a match-up with metadata which is sent either with electronic program guide data or as a separate stream (shown in FIG. 5) or as adaptation data. The ad identification could also be sent as private data in the adaptation layer of the ad video.

Advertisements 170, 172, 174 and 176 are thereby linked to their associated metadata respectively 180, 182, 184 and 186 which is stored, transmitted and received as a separate stream of data that is identified by a packet identifier (PID) that may be different than any of the packet identifiers otherwise associated with programming 150. Again, in certain implementations, the ad metadata can include a product or service description, a company name, a starting frame number, an ending frame number and either data that forms a video image thumbnail or a frame number containing an I-Frame of MPEG video that is to be used as a thumbnail.

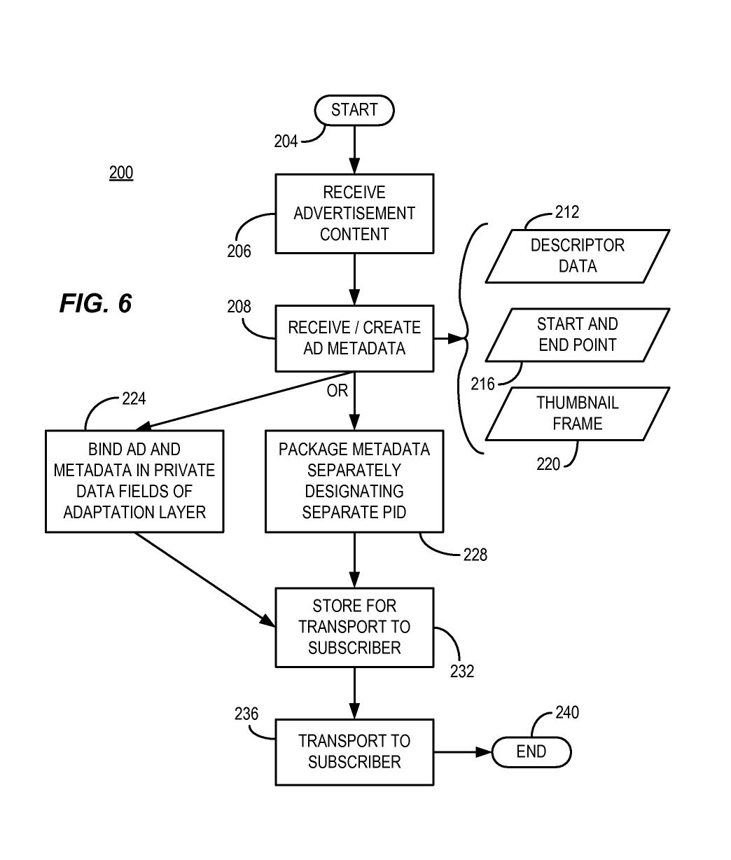

The advertisement data is pre-assembled into the data structure which supports the metadata and use thereof. This data structure can be produced at any point in the advertisement delivery process including during production of the advertisement or during packaging of the advertisement by the distribution network (e.g., an MSO, cable, satellite, broadcast or Telco). An example implementation of the packaging of the advertisement content is depicted as process 200 of FIG. 6. Implementation is similar for either of the two embodiments discussed above with minor deviations as will be described. The process starts at 204 with the advertisement content being received at 206. Advertisement metadata associated with the advertisements are either received or created at 208. In this example, the advertisement metadata are depicted as descriptor data 212 (e.g., a product or service or company name or combination thereof), a start and end point 216 (e.g., a packet number for starting packet and a packet number for ending packet), and an identifier for a thumbnail frame 220 (e.g., a starting packet number for an MPEG I-Frame containing a frame to be used as a thumbnail, or video data to produce the thumbnail).

At this point, the metadata and the advertisement data can be associated or bound together using any of the approaches described above or others that will occur to those skilled in the art upon consideration of the present teachings. In one case, control passes from 208 to 224 where the advertisement and associated metadata are bound in private data fields of the adaptation layer for transport to the recipient subscriber. In the other case, at 228 the metadata are packaged separately designating a PID for the metadata. This is also suitable for delivering ads from the headend by tying to those PIDs as separate sessions. So the receiver can either establish a separate session on a different frequency for the AD and then tune back or additional PID filters can be opened for the AD PIDs or the receiver tunes to the AD PIDs and after the AD is over tunes back to the original PIDs. This PID is then communicated to the receiver using, for example, the technique described above in connection with the AD Identification Table. The PVR records the full transport stream as opposed to just the program and nulls. The PID can be carried in a table with other tables in a predetermined location such as PID 00 or 01. At this point, the advertisement and metadata in whatever form is stored for transport to the subscriber at 232, and at the appropriate point transported to the subscriber at 236, after which the process ends at 240.

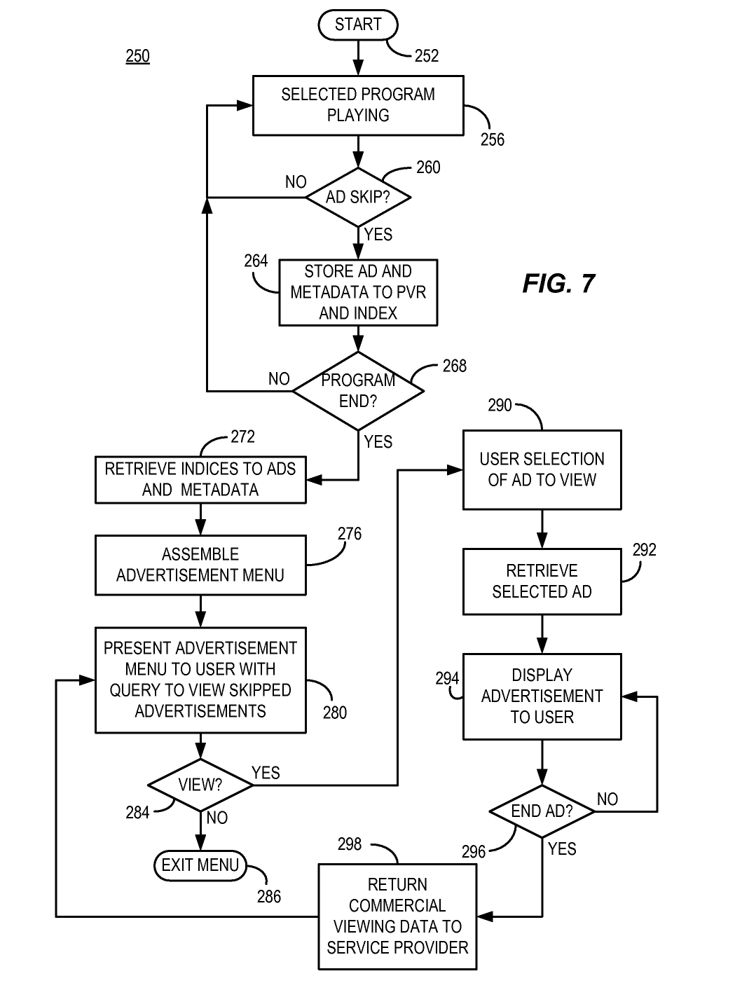

At the subscriber side, in accord with one example implementation as depicted by process 250 of FIG. 7 starts at 252. When the user selects a program for play, the selected program begins playing at 256 until an advertisement is encountered. If no action is taken by the user to skip or fast forward through the advertisement, the advertisement plays normally. But, if the user takes an action at 260 to skip the advertisement, the advertisement is skipped and the ad and associated metadata remain stored in the PVR, and an index to the skipped ad is created and stored. This index is later used to compile a menu of skipped advertisements.

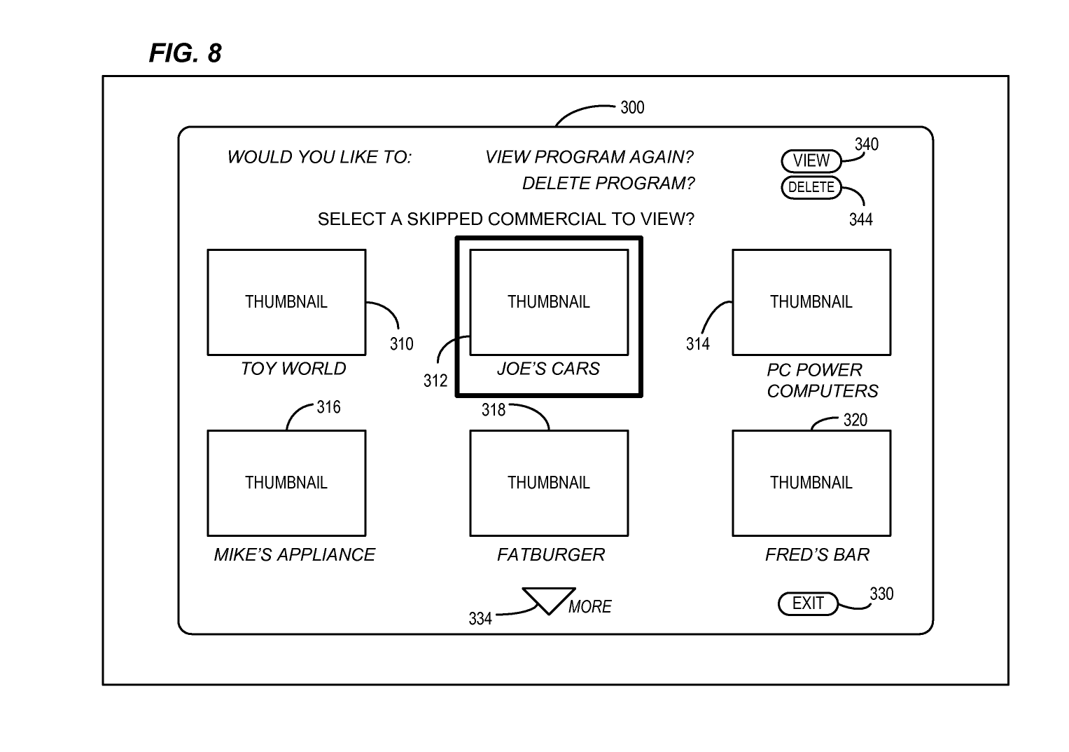

Program play proceeds at 256 until the program ends at 268. The program can be determined to be ended when the file stored on the PVR comes to an end. The start and end can also be determined via the Guide data. At this point, the PVR retrieves the stored indices that index the skipped advertisements and uses these indices to retrieve the metadata associated with the skipped advertisements at 272. The PVR then assembles an advertisement menu at 276, preferably having at least a descriptor of the advertisement and a thumbnail for each advertisement. This menu is then displayed for the user, for example as a pop-up menu along with at least an explicit or implicit query that invites the user to view the skipped advertisements. (An example pop-up menu is shown in FIG. 8 and will be discussed later.) The user is then exposed at least to thumbnail images that can serve as an advertisement in their own right so that the advertiser gets some level of advertising benefit from his advertisements. The user can then elect to view the advertisement at 284 or not. If not, the menu is closed and exited at 286.

If the user chooses to view an advertisement at 284, control passes to 290 where the user selects an advertisement to view by manipulation of a cursor to the advertisement to view using remote control navigation controls and making a selection. The advertisement is then retrieved at 292 and displayed to the user at 294. Once the advertisement end is reached at 296, in certain embodiments, data relating to the user's commercial viewing activity can be returned to the service provider in order to provide feedback on viewing habits, interests and assist in profiling the type of advertisements that have been of interest to the viewer. This feedback can facilitate targeted advertisement. The level of targeting can be varied with more anonymity with node level targeting (where individual user is anonymous, but statistics are collected at node level for collective targeting of individual users). Control then passes back to 280 where the advertisement menu is displayed again until the user has watched all he or she chooses to watch and elects to exit at 286.

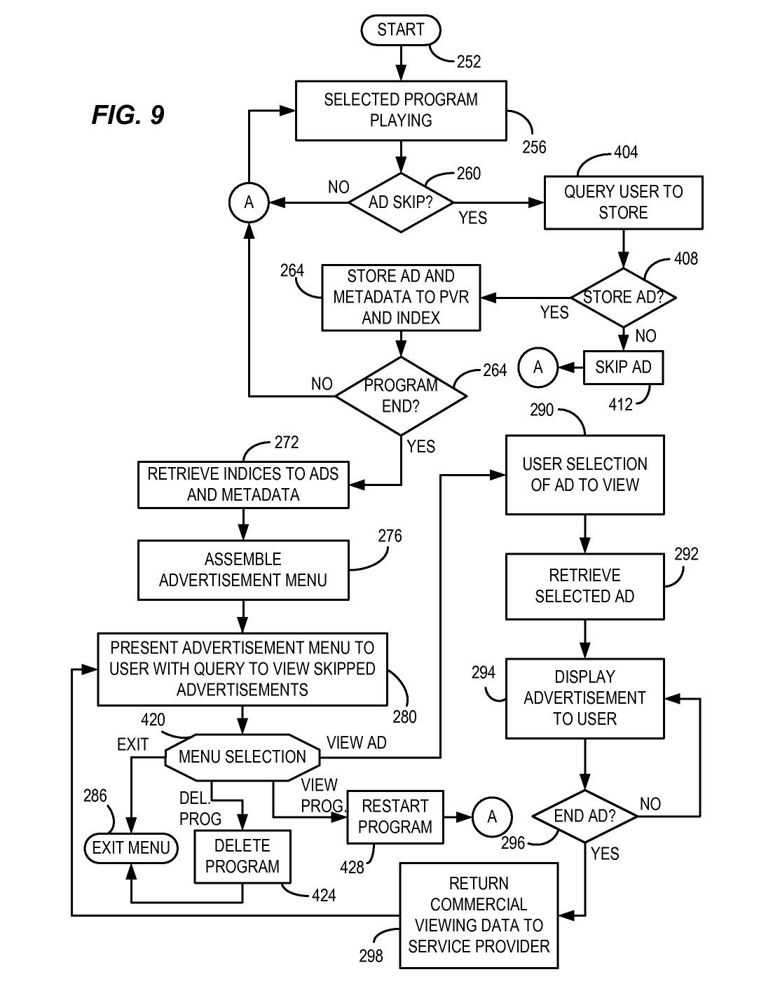

Many variations of this process are possible, a few of which will be shown in connection with FIG. 9, but which may be equally well incorporated into process 250.

Referring now to FIG. 8, an example implementation of a user interface for the pop-up menu described above is depicted as screen shot 300. In this screen, the user is queried if he or she would like to select a skipped commercial to view. The user, in this example, is presented with six commercial advertisements 310, 312, 314, 316, 318 and 320, each having its own thumbnail with a descriptor situated below it. In practice, the PVR generates a signal representing the menu which is suitable for display on the TV display. The user can make a selection by moving a cursor or highlighting using whatever navigation controls are available in the particular hardware at hand to focus on the target advertisement. In this example, advertisement 312 is indicated to be in focus by the dark box surrounding the selection. The user then selects “ENTER” or “SELECT” or an equivalent command from the remote controller in order to select the desired advertisement. In certain embodiments, the remote controller can use up, down, left and right arrows to move among the available selections. The “EXIT” selection 330 can be made to close down the menu and indicate that the user has finished viewing the advertisements or does not wish to view the advertisements. In the event more advertisements are available than can fit on one screen, another screen can be accessed by selecting the down arrow icon (MORE) 334.

The basic functions as described in connection with process 250 have been explained in connection with FIG. 8 up to this point. Other menu selections are also possible as are shown in menu 300 as well as will be described in connection with FIG. 9. Such additional menu options may include an option to view the same program again by selection of icon 340, or to delete the program just viewed at 344 in order to free up storage space in the PVR. Other menu options can also be incorporated in this menu to facilitate its utility while simultaneously exposing the user to at least the advertisement thumbnails and descriptors. For example, direct navigation to an EPG page or other functions can also be implemented without departing from embodiments consistent with the present invention. Other variations will occur to those skilled in the art upon consideration of the present teachings.

Referring now to FIG. 9, process 400 is depicted showing several variations of the process shown in FIG. 7 as process 250. In this process 400, blocks that bear the same reference number operate in the same manner as described previously. In this process, however, if the user elects to skip an advertisement at 260, the user is presented with a query in order to ask the user if he or she wishes to store the advertisement for later viewing at 404. Although the advertisement is already stored in the PVR, the PVR interprets a positive response from the user at 408 as an indication to store an index to the advertisement at 264 for use in producing a menu later and for purposes of providing feedback to the service provider. The invitation at 404 to the user to store the ad, can include identification information from the metadata (the descriptor) and may also use the thumbnail as a part of the query so as to expose the user to this information at the time of the query. If the user declines to store the ad at 408, the advertisement is skipped at 412 and control returns to 256 where the program play continues.

When the user is presented with a menu such as 300 at 420, the user can exit at 286 or view one or more advertisements at 290. Alternatively, the user can elect to restart the program at 424 or delete the program at 428. Other variations can be implemented as menu selections at 420 invoking paths or routines that implement other functions as will be clear to those skilled in the art upon consideration of the present teachings.

Thus, a method of operation of a personal video recorder (PVR) involves receiving and storing a plurality of commercial advertisements forming a part of a stream of program content at the PVR; receiving and storing metadata associated with the plurality of commercial advertisements at the PVR; determining that the PVR has received a command to skip during play of one or more of the commercial advertisements; as a result of the determining, storing an index to the one or more commercial advertisements that were skipped at the PVR; ascertaining that the end of the stream of program content has been reached; as a result of the ascertaining, using the stored index to retrieve metadata associated with the one or more skipped commercial advertisements; building a menu of skipped commercial advertisements from the retrieved metadata for the skipped advertisements; generating a signal that displays the menu to the user and provides the user with an option of viewing the skipped commercials; if the user chooses not to view the skipped commercials, ceasing to generate the signal that displays the menu; if the user chooses to view a skipped commercial, then receiving a selection of a commercial advertisement that the user wishes to view; and retrieving the commercial advertisement for viewing by the user.

In certain implementations, the metadata comprises descriptor data that describes the commercial advertisement, a starting point for the commercial advertisement; an ending point for the commercial advertisement, and data relating to a thumbnail image. In certain implementations, the data relating to the thumbnail image comprises video image data. In certain implementations, the data relating to the thumbnail image comprises a packet number for a starting packet for an MPEG I-Frame to be used for the thumbnail image. In certain implementations, the metadata are bound to the advertisement's private data fields of an adaptation layer. In certain implementations, the metadata is sent with electronic guide data as sub-segments of a program. In certain implementations, the metadata are received in a separate data stream designated by a specified packet identifier. In certain implementations, as a result of the determining, querying the user to determine if the advertisement should be stored. In certain implementations, the menu further provides an option to delete the program content. In certain implementations, the menu further provides an option to view the program content again.

Another method of operation of a personal video recorder (PVR) involves receiving and storing a plurality of commercial advertisements forming a part of a stream of program content at the PVR; receiving and storing metadata associated with the plurality of commercial advertisements at the PVR, wherein the metadata comprises descriptor data that describes the commercial advertisement, a starting point for the commercial advertisement; an ending point for the commercial advertisement, and a packet number for a starting packet for an MPEG I-Frame to be used for the thumbnail image relating to a thumbnail image; wherein the metadata is sent with electronic guide data as sub-segments of a program; determining that the PVR has received a command to skip during play of one or more of the commercial advertisements; as a result of the determining, querying the user to determine if the advertisement should be stored; as a result of the determining, storing an index to the one or more commercial advertisements that were skipped at the PVR; ascertaining that the end of the stream of program content has been reached; as a result of the ascertaining, using the stored index to retrieve metadata associated with the one or more skipped commercial advertisements; building a menu of skipped commercial advertisements from the retrieved metadata for the skipped advertisements; wherein the menu further provides an option to delete the program content, and provides an option to view the program content again; generating a signal that displays the menu to the user and provides the user with an option of viewing the skipped commercials; if the user chooses not to view the skipped commercials, ceasing to generate the signal that displays the menu; if the user chooses to view a skipped commercial, then receiving a selection of a commercial advertisement that the user wishes to view; and retrieving the commercial advertisement for viewing by the user.

Another method of operation of a personal video recorder (PVR) involves receiving and storing a plurality of commercial advertisements forming a part of a stream of program content at the PVR; receiving and storing metadata associated with the plurality of commercial advertisements at the PVR; storing an index to the one or more commercial advertisements at the PVR; ascertaining that the end of the stream of program content has been reached; as a result of the ascertaining, using the stored index to retrieve metadata associated with the one or more commercial advertisements; building a menu of commercial advertisements from the retrieved metadata for the advertisements; generating a signal that displays the menu to the user and provides the user with an option of viewing the commercials; if the user chooses not to view the commercials, ceasing to generate the signal that displays the menu; if the user chooses to view a commercial, then receiving a selection of a commercial advertisement that the user wishes to view; and retrieving the commercial advertisement for viewing by the user.

In certain implementations, the metadata and index to commercials is for skipped commercials. In certain implementations, the commercials and program content is broadcast from one of satellite, terrestrial, or cable. In certain implementations, the metadata comprises descriptor data that describes the commercial advertisement, a starting point for the commercial advertisement; an ending point for the commercial advertisement, and data relating to a thumbnail image. In certain implementations, the data relating to the thumbnail image comprises video image data. In certain implementations, the data relating to the thumbnail image comprises a packet number for a starting packet for an MPEG I-Frame to be used for the thumbnail image. In certain implementations, the metadata are bound to the advertisement's private data fields of an adaptation layer. In certain implementations, the metadata is sent with electronic guide data as sub-segments of a program. In certain implementations, the metadata are received in a separate data stream designated by a specified packet identifier.

A tangible computer readable electronic storage medium can store instructions which, when executed on one or more programmed processors, carry out any of the above methods.

Certain embodiments described herein, are or may be implemented using a programmed processor residing at the service provider headend or at the PVR operating in the mode of a controller executing programming instructions that are broadly described above in flow chart form that can be stored on any suitable electronic or computer readable storage medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. In addition, the programmed processor implementations can equivalently realized by equivalent hardware logic circuits and the like without departing from embodiments consistent with the present invention. Such variations are contemplated and considered equivalent.

While certain illustrative embodiments have been described, it is evident that many alternatives, modifications, permutations and variations will become apparent to those skilled in the art in light of the foregoing description.

What is claimed is:

1. A method of operation of a personal video recorder (PVR), comprising:
receiving and storing a plurality of commercial advertisements forming a part of a stream of program content at the PVR;
receiving and storing metadata associated with the plurality of commercial advertisements at the PVR;
storing an index to the one or more commercial advertisements at the PVR;
ascertaining that the end of the stream of program content has been reached;
as a result of the ascertaining, using the stored index to retrieve metadata associated with the one or more commercial advertisements;
building a menu of commercial advertisements from the retrieved metadata for the advertisements;
generating a signal that displays the menu to the user and provides the user with an option of viewing the commercials;
if the user chooses not to view the commercials, ceasing to generate the signal that displays the menu;
if the user chooses to view a commercial, then receiving a selection of a commercial advertisement that the user wishes to view; and
retrieving the commercial advertisement for viewing by the user.

2. The method of operation of a personal video recorder according to claim 1, wherein the metadata comprises descriptor data that describes the commercial advertisement, a starting point for the commercial advertisement; an ending point for the commercial advertisement, and data relating to a thumbnail image.

3. The method of operation of a personal video recorder according to claim 2, wherein the data relating to the thumbnail image comprises video image data.

4. The method of operation of a personal video recorder according to claim 2, wherein the data relating to the thumbnail image comprises a packet number for a starting packet for an MPEG I-Frame to be used for the thumbnail image.

5. The method of operation of a personal video recorder according to claim 1, wherein the metadata are bound to the advertisement's private data fields of an adaptation layer.

6. The method of operation of a personal video recorder according to claim 1, wherein the metadata is sent with electronic guide data as sub-segments of a program.

7. The method of operation of a personal video recorder according to claim 1, wherein the metadata are received in a separate data stream designated by a specified packet identifier.

8. The method of operation of a personal video recorder according to claim 1, further comprising as a result of the determining, querying the user to determine if the advertisement should be stored.

9. The method of operation of a personal video recorder according to claim 1, wherein the menu further provides an option to delete the program content.

10. The method of operation of a personal video recorder according to claim 1, wherein the menu further provides an option to view the program content again.

11. A computer readable storage medium storing instructions which, when executed on one or more programmed processors, carry out a method according to claim 1.

12. A method of operation of a personal video recorder (PVR), comprising:
receiving and storing a plurality of commercial advertisements forming a part of a stream of program content at the PVR;
receiving and storing metadata associated with the plurality of commercial advertisements at the PVR, wherein the metadata comprises descriptor data that describes the commercial advertisement, a starting point for the commercial advertisement, an ending point for the commercial advertisement, and a packet number for a starting packet for an MPEG I-Frame to be used for the thumbnail image relating to a thumbnail image;
wherein the metadata is sent with electronic guide data as sub-segments of a program; determining that the PVR has received a command to skip during play of one or more of the commercial advertisements;
as a result of the determining, querying the user to determine if the advertisement should be stored;
as a result of the determining, storing an index to the one or more commercial advertisements that were skipped at the PVR;
ascertaining that the end of the stream of program content has been reached;
as a result of the ascertaining, using the stored index to retrieve metadata associated with the one or more skipped commercial advertisements;
building a menu of skipped commercial advertisements from the retrieved metadata for the skipped advertisements;
wherein the menu further provides an option to delete the program content, and provides an option to view the program content again;
generating a signal that displays the menu to the user and provides the user with an option of viewing the skipped commercials;
if the user chooses not to view the skipped commercials, ceasing to generate the signal that displays the menu;
if the user chooses to view a skipped commercial, then receiving a selection of a commercial advertisement that the user wishes to view; and
retrieving the commercial advertisement for viewing by the user.

13. A method of operation of a personal video recorder (PVR) comprising:
receiving and storing a plurality of commercial advertisements forming a part of a stream of program content at the PVR;
receiving and storing metadata associated with the plurality of commercial advertisements at the PVR;
storing an index to the one or more commercial advertisements at the PVR;
ascertaining that the end of the stream of program content has been reached;
as a result of the ascertaining, using the stored index to retrieve metadata associated with the one or more commercial advertisements;
building a menu of commercial advertisements from the retrieved metadata for the advertisements;
generating a signal that displays the menu to the user and provides the user with an option of viewing the commercials;
if the user chooses not to view the commercials, ceasing to generate the signal that displays the menu;
if the user chooses to view a commercial, then receiving a selection of a commercial advertisement that the user wishes to view; and
retrieving the commercial advertisement for viewing by the user.

14. The method of operation of a personal video recorder according to claim 13, wherein the metadata and index to commercials is for skipped commercials.

15. The method of operation of a personal video recorder according to claim 13, wherein the metadata comprises descriptor data that describes the commercial advertisement, a starting point for the commercial advertisement; an ending point for the commercial advertisement, and data relating to a thumbnail image.

16. The method of operation of a personal video recorder according to claim 15, wherein the data relating to the thumbnail image comprises video image data.

17. The method of operation of a personal video recorder according to claim 15, wherein the data relating to the thumbnail image comprises a packet number for a starting packet for an MPEG I-Frame to be used for the thumbnail image.

18. The method of operation of a personal video recorder according to claim 13, wherein the metadata are bound to the advertisement's private data fields of an adaptation layer.

19. The method of operation of a personal video recorder according to claim 13, wherein the metadata is sent with electronic guide data as sub-segments of a program.

20. The method of operation of a personal video recorder according to claim 13, wherein the metadata are received in a separate data stream designated by a specified packet identifier.

21. A method of operation of a personal video recorder (PVR), comprising:
receiving and storing a plurality of commercial advertisements forming a part of a stream of program content at the PVR as separate files;
receiving and storing metadata associated with the plurality of commercial advertisements at the PVR;
creating a list of one or more the one or more commercial advertisements that were recorded during a program;
ascertaining that the end of the stream of program content has been reached;
as a result of the ascertaining, using the list of commercials to retrieve metadata associated with the one or more commercial advertisements;
building a menu of commercial advertisements from the retrieved metadata for the advertisements;
generating a signal that displays the menu to the user and provides the user with an option of viewing the commercials;
if the user chooses not to view the commercials, ceasing to generate the signal that displays the menu;
if the user chooses to view a commercial, then receiving a selection of a commercial advertisement that the user wishes to view; and
retrieving the commercial advertisement file for viewing by the user.

22. The method of operation of a personal video recorder according to claim 21, wherein the metadata and index to commercials is for skipped commercials.

23. The method of operation of a personal video recorder according to claim 21, wherein the commercials and program content is broadcast from one of satellite, terrestrial, or cable.

24. The method of operation of a personal video recorder according to claim 21, wherein the metadata comprises descriptor data that describes the commercial advertisement, a starting point for the commercial advertisement; an ending point for the commercial advertisement, and data relating to a thumbnail image.

25. The method of operation of a personal video recorder according to claim 24, wherein the data relating to the thumbnail image comprises video image data.

26. The method of operation of a personal video recorder according to claim 24, wherein the data relating to the thumbnail image comprises a packet number for a starting packet for an MPEG I-Frame to be used for the thumbnail image.

27. The method of operation of a personal video recorder according to claim 21, wherein the metadata are bound to the advertisement's private data fields of an adaptation layer.

28. The method of operation of a personal video recorder according to claim 21, wherein the metadata is sent with electronic guide data as sub-segments of a program.

29. The method of operation of a personal video recorder according to claim 21, wherein the metadata are received in a separate data stream designated by a specified packet identifier.
